(19) United States
(12) Patent Application Publication
(10) Pub. No.: US 2022/0289253 A1
(43) Pub. Date: Sep. 15, 2022

(54) METHOD FOR EVALUATING AUTONOMOUS DRIVING SYSTEM, APPARATUS AND STORAGE MEDIUM

(71) Applicant: Baidu USA LLC, Sunnyvale, CA (US)

(72) Inventors: Zhisheng Hu, Sunnyvale, CA (US); Shengjian Guo, Sunnyvale, CA (US); Xinyang Zhang, Sunnyvale, CA (US); Zhenyu Zhong, Sunnyvale, CA (US)

(21) Appl. No.: 17/824,686

(22) Filed: May 25, 2022

(51) Int. Cl. B60W 60/00; G06F 21/57; G06F 21/53

(52) U.S. Cl. CPC B60W 60/00188; G06F 21/57; G06F 21/53

(57) ABSTRACT

A method for evaluating an autonomous driving system, an apparatus, and a storage medium are provided. The method includes: determining an attack or a defense, where the attack is a first input configured to increase an error rate of a component of the autonomous driving system, and the defense is a second input configured to decrease the error rate; simulating a driving scenario of a vehicle, where the driving scenario includes a driving environment and a vehicle configuration; applying the attack or the defense on at least one of the autonomous driving system, or the driving scenario; generating, by the autonomous driving system based on the driving scenario, an instruction of controlling a traveling of the vehicle in the driving scenario; simulating the traveling of the vehicle in the driving scenario based on the instruction; and determining an evaluation result based on a traveling result of the vehicle.

### TECHNICAL FIELD

Embodiments of the present disclosure relate generally to the field of autonomous driving, and more particularly, to a method for evaluating an autonomous driving system, an apparatus and a storage medium.

### BACKGROUND

An autonomous driving vehicle (ADV) can operate in an autonomous mode (e.g., driverless) and thus can relieve occupants, especially the driver, from some driving-related responsibilities. When operating in an autonomous mode, the autonomous vehicle can be controlled by an automatic driving system to navigate to various locations.

In complex driving scenarios, safety of the automatic driving system in the ADV attracts lots of attention from users of the ADV. Particularly, for various driving scenarios or various safety events (e.g. attacks/defenses to the ADV) that may cause driving safety concerns, a system-level safety performance evaluation of the autonomous driving system is of great importance for some reasons. For instance, a component in the autonomous driving system is likely to affect the entire performance of the autonomous driving system. These days, performance evaluation of a single component has been developed rapidly. However, there are still large demands for the system-level safety performance evaluation, so as to further improve the safety of the ADV.

### SUMMARY

In a first aspect, a method for evaluating an autonomous driving system is provided. The method includes: determining an attack or a defense, where the attack is a first input configured to increase an error rate of a component of the autonomous driving system, and the defense is a second input configured to decrease the error rate of the component of the autonomous driving system; simulating a driving scenario of a vehicle, where the driving scenario includes a driving environment and a vehicle configuration; applying the attack or the defense on at least one of the autonomous driving system, or the driving scenario; generating, by the autonomous driving system based on the driving scenario, an instruction of controlling a traveling of the vehicle in the driving scenario; simulating the traveling of the vehicle in the driving scenario based on the instruction; and determining an evaluation result based on a traveling result of the vehicle.

In a second aspect, an apparatus is provided. The apparatus includes a processor, and a memory storing instructions, which when executed by the processor, cause the processor to perform the method according to the first aspect.

In a third aspect, a non-transitory storage medium storing instructions is provided. The instructions when executed by a processor cause the processor to perform the method according to the first aspect.

### BRIEF DESCRIPTION OF THE DRAWINGS

The above and other features, advantages and aspects of the embodiments of the present disclosure will become more apparent from the following detailed description in conjunction with the accompanying drawings. In the drawings, the same or similar reference numerals denote the same or similar elements, where:

FIG. 1 is a block diagram illustrating an autonomous vehicle network configuration according to some embodiments of the disclosure;

FIG. 2 is a block diagram illustrating an example of an autonomous vehicle according to some embodiments of the disclosure;

FIGS. 3A-3B are block diagrams illustrating an example of an autonomous driving system used with an autonomous vehicle according to some embodiments of the disclosure;

FIG. 4 illustrates a platform for auto-driving safety and security (PASS) according to some embodiments of the disclosure;

FIG. 5 illustrates a method for evaluating an autonomous driving system according to some embodiments of the disclosure;

FIG. 6 illustrates an implementation of selecting the attack, the defense or a combination of the attack and the defense from a first sub-interface according to some embodiments of the disclosure;

FIG. 7 illustrates a main interface of the PASS according to some embodiments of the disclosure;

FIG. 8 illustrates a first sub-interface of the PASS according to some embodiments of the disclosure; and

FIG. 9 illustrates an apparatus according to some embodiments of the disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

In the related technology, it is recognized that a behavior of a component in an autonomous driving vehicle (ADV) may not necessarily lead to an impact on the entire autonomous driving (AD) system in the ADV. For example, when a mis-detected object is located at a far distance for automatic emergency braking, or a misdetection can be tolerated by a subsequent component, such as an object tracking component, the entire AD system is not affected. However, system-level evaluation is generally lacking in existing AD AI security/safety works. Only component-level evaluation (e.g., analyzing model accuracy without involving any interactions/integration with other AI components in AD systems) is adopted.

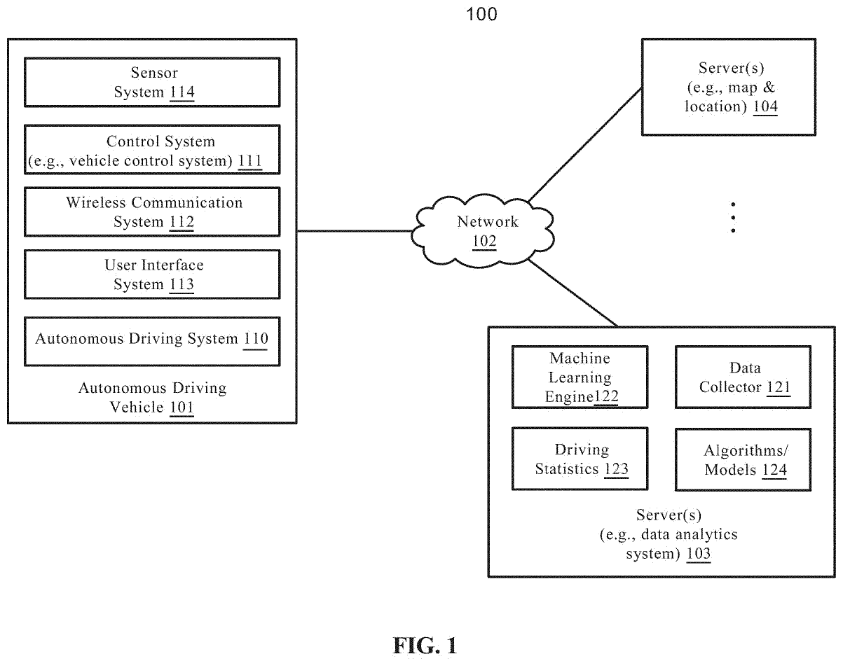

FIG. 1 is a block diagram illustrating an autonomous vehicle network configuration according to some embodiments of the disclosure. Referring to FIG. 1, network configuration 100 includes autonomous vehicle 101 that may be communicatively coupled to one or more servers 103-104 over a network 102. Although there is one autonomous vehicle shown, multiple autonomous vehicles can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An autonomous vehicle refers to a vehicle that can be configured to in an autonomous mode in which the vehicle navigates through an environment with little or no input from a driver. Such an autonomous vehicle can include a sensor system having one or more sensors that are configured to detect information about the environment in which the vehicle operates. The vehicle and its associated controller(s) use the detected information to navigate through the environment. Autonomous vehicle 101 can operate in a manual mode, a full autonomous mode, or a partial autonomous mode.

In some embodiments, autonomous vehicle 101 includes, but is not limited to, autonomous driving system (i.e., perception and planning system) 110, vehicle control system 111, wireless communication system 112, user interface system 113, and sensor system 114. In some embodiments, the autonomous vehicle further includes an infotainment system (not shown). Autonomous vehicle 101 may further include certain common components included in ordinary vehicles, such as, an engine, wheels, steering wheel, transmission, etc., which may be controlled by vehicle control system 111 and/or perception and planning system 110 using a variety of communication signals and/or commands, such as, for example, acceleration signals or commands, deceleration signals or commands, steering signals or commands, braking signals or commands, etc.

Components 110-114 may be communicatively coupled to each other via an interconnect, a bus, a network, or a combination thereof. For example, components 110-114 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

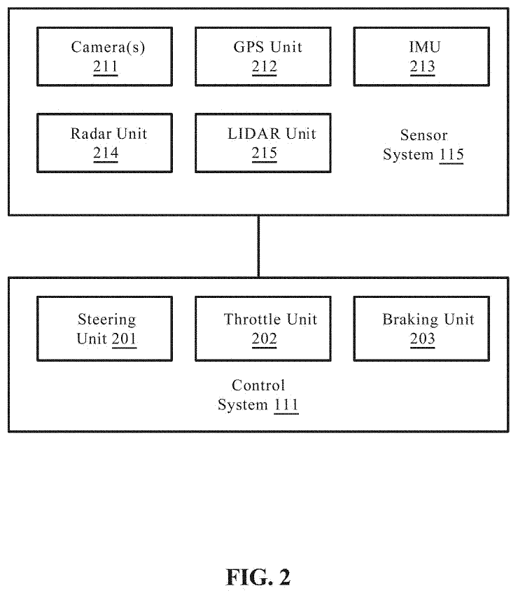

Referring now to FIG. 2, in some embodiments, sensor system 114 includes, but it is not limited to, one or more cameras 211, global positioning system (GPS) unit 212, inertial measurement unit (IMU) 213, radar unit 214, and a light detection and range (LIDAR) unit 215. GPS unit 212 may include a transceiver operable to provide information regarding the position of the autonomous vehicle. IMU unit 213 may sense position and orientation changes of the autonomous vehicle based on inertial acceleration. Radar unit 214 may represent a system that utilizes radio signals to sense objects within the local environment of the autonomous vehicle. In some embodiments, in addition to sensing objects, radar unit 214 may additionally sense the speed and/or heading of the objects. LIDAR unit 215 may sense objects in the environment in which the autonomous vehicle is located using lasers. LIDAR unit 215 could include one or more laser sources, a laser scanner, and one or more detectors, among other system components. Cameras 211 may include one or more devices to capture images of the environment surrounding the autonomous vehicle. Cameras 211 may be still cameras and/or video cameras. A camera may be mechanically movable, for example, by mounting the camera on a rotating and/or tilting a platform.

Sensor system 114 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the autonomous vehicle. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In some embodiments, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between autonomous vehicle 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of autonomous vehicle 101 may be controlled or managed by perception and planning system 110, especially when operating in an autonomous driving mode. Perception and planning system 110 includes the necessary hardware (e.g., processor(s), memory, storage) and software (e.g., operating system, planning and routing programs) to receive information from sensor system 114, control system 111, wireless communication system 112, and/or user interface system 113, process the received information, plan a route or path from a starting point to a destination point, and then drive vehicle 101 based on the planning and control information. Alternatively, perception and planning system 110 may be integrated with vehicle control system 111.

For example, a user as a passenger may specify a starting location and a destination of a trip, for example, via a user interface. Perception and planning system 110 obtains the trip related data. For example, perception and planning system 110 may obtain location and route information from an MPOI server, which may be a part of servers 103-104. The location server provides location services and the MPOI server provides map services and the POIs of certain locations. Alternatively, such location and MPOI information may be cached locally in a persistent storage device of perception and planning system 110.

While autonomous vehicle 101 is moving along the route, perception and planning system 110 may also obtain real-time traffic information from a traffic information system or server (TIS). Note that servers 103-104 may be operated by a third party entity. Alternatively, the functionalities of servers 103-104 may be integrated with perception and planning system 110. Based on the real-time traffic information, MPOI information, and location information, as well as real-time local environment data detected or sensed by sensor system 114 (e.g., obstacles, objects, nearby vehicles), perception and planning system 110 can plan an optimal route and drive vehicle 101, for example, via control system 111, according to the planned route to reach the specified destination safely and efficiently.

Server 103 may be a data analytics system to perform data analytics services for a variety of clients. In some embodiments, data analytics system 103 includes data collector 121 and machine learning engine 122. Data collector 121 collects driving statistics 123 from a variety of vehicles, either autonomous vehicles or regular vehicles driven by human drivers. Driving statistics 123 include information indicating the driving commands (e.g., throttle, brake, steering commands) issued and responses of the vehicles (e.g., speeds, accelerations, decelerations, directions) captured by sensors of the vehicles at different points in time. Driving statistics 123 may further include information describing the driving environments at different points in time, such as, for example, routes (including starting and destination locations), MPOIs, road conditions, weather conditions, etc.

Based on driving statistics 123, machine learning engine 122 generates or trains a set of rules, algorithms, and/or predictive models 124 for a variety of purposes. Algorithms 124 can then be uploaded on ADVs to be utilized during autonomous driving in real-time.

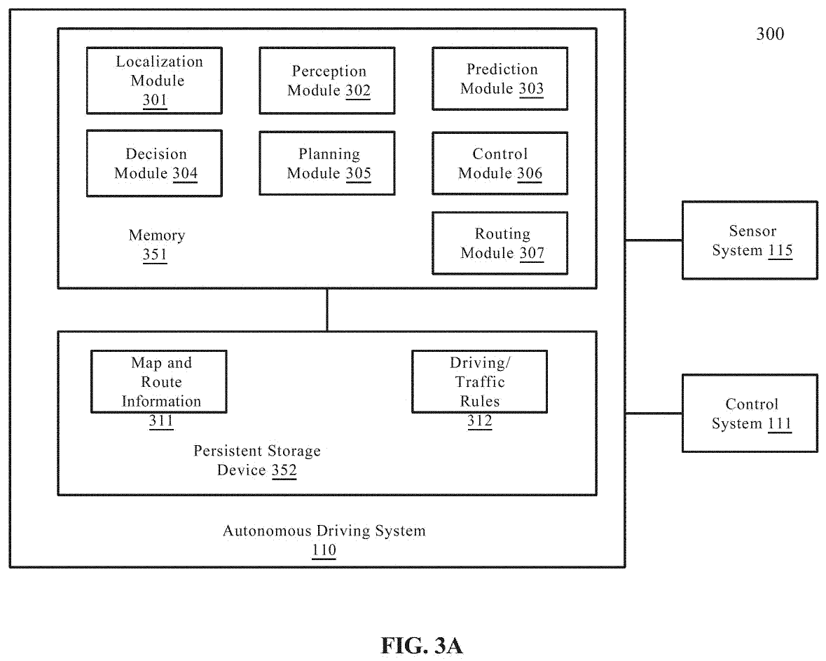

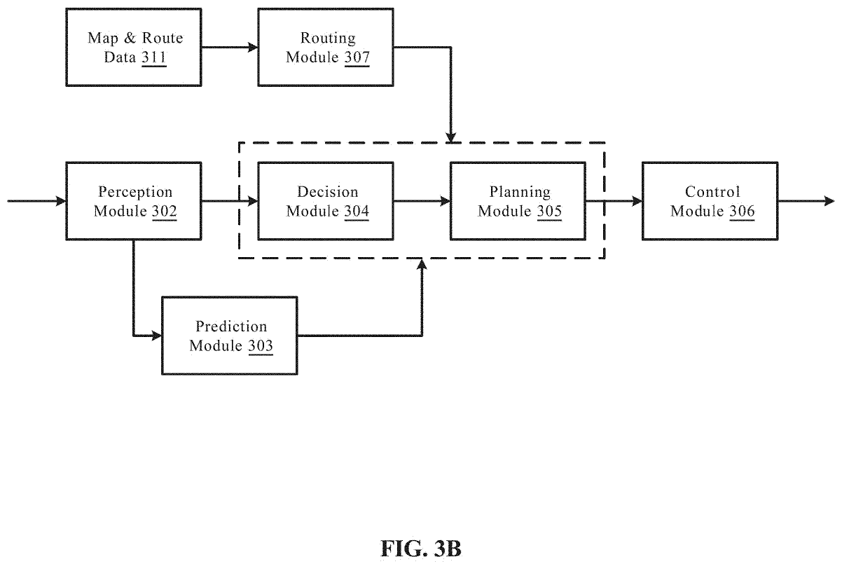

FIGS. 3A and 3B are block diagrams illustrating an example of an autonomous driving system (i.e., perception and planning system) used with an autonomous vehicle according to some embodiments. System 300 may be implemented as a part of autonomous vehicle 101 of FIG. 1 including, but is not limited to, perception and planning system 110, control system 111, and sensor system 114. Referring to FIGS. 3A-3B, perception and planning system 110 includes, but is not limited to, localization module 301, perception module 302, prediction module 303, decision module 304, planning module 305, control module 306, and routing module 307.

Some or all of modules 301-307 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-307 may be integrated together as an integrated module.

Localization module 301 determines a current location of autonomous vehicle 101 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of autonomous vehicle 101, such as map and route information 311, to obtain the trip related data. For example, localization module 301 may obtain location and route information from a location server and a map and POI (MPOI) server. A location server provides location services and an MPOI server provides map services and the POIs of certain locations, which may be cached as part of map and route information 311. While autonomous vehicle 101 is moving along the route, localization module 301 may also obtain real-time traffic information from a traffic information system or server.

Based on the sensor data provided by sensor system 114 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of autonomous vehicle. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/rout information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the autonomous vehicle, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how autonomous vehicle 101 would move in a next moving cycle (e.g., next route/path segment). For example, the planning and control data may instruct autonomous vehicle 101 to move 10 meters at a speed of 30 mile per hour (mph), then change to a right lane at the speed of 25 mph.

Based on the planning and control data, control module 306 controls and drives the autonomous vehicle, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In some embodiments, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the autonomous vehicle. For example, the navigation system may determine a series of speeds and directional headings to affect movement of the autonomous vehicle along a path that substantially avoids perceived obstacles while generally advancing the autonomous vehicle along a roadway-based path leading to an ultimate destination. The destination may be set according to user inputs via user interface system 113. The navigation system may update the driving path dynamically while the autonomous vehicle is in operation. The navigation system can incorporate data from a GPS system and one or more maps so as to determine the driving path for the autonomous vehicle.

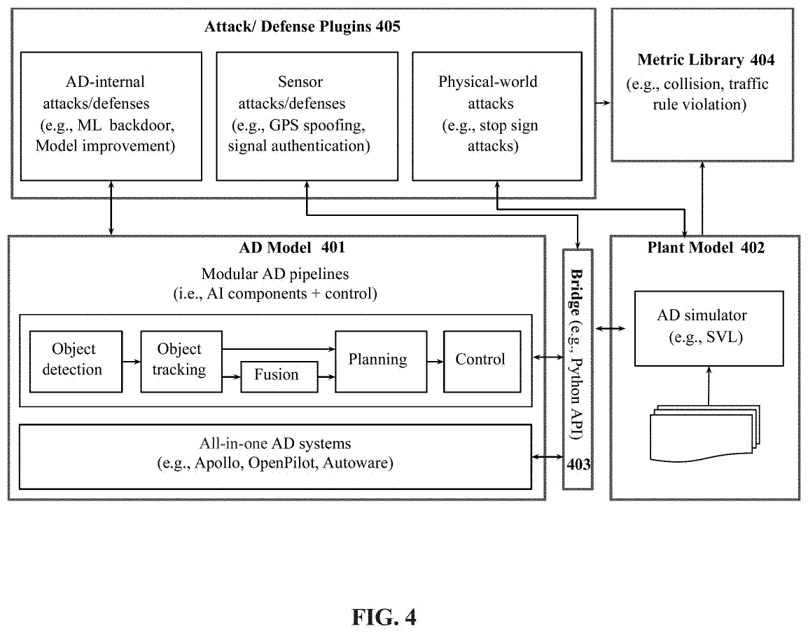

FIG. 4 illustrates a platform for auto-driving safety and security (PASS) according to some embodiments of the disclosure.

The main goal of PASS is building a uniform and extensible system-driven evaluation platform for various AI (artificial intelligence) safety and security works in the AD context. In some embodiments, to achieve uniformity, evaluation scenarios and metrics are unified so that the evaluation results of different works can be intuitively visible and comparable. In some embodiments, attack and defense implementations, evaluation setup and AD design are standardized and modular so that the existing works can be easily reproduced and new attacks or defenses, AD system designs, and evaluation scenarios can be collectively developed by researchers to fit future needs.

In some embodiments, PASS provides a modular AD system pipeline 401, including AI components commonly targeted by attacks or defenses. In some embodiments, the modular AD system is the AD system shown in FIG. 3A, and the AI components commonly target by attacks or defenses are the localization module 301, the perception module 302, the prediction module 303, the decision module 304, and the planning module 305. In some embodiments, each AI component is designed to be replaceable for future needs. In some embodiments, the modular AD system is an all-in-one AD system such as Apollo Opensource, OpenPilot and Autoware.

The plant model 402 of PASS includes vehicle kinematics and physical driving environment. In some embodiments, a simulator SVL is used to provide the plant model. Compared to real vehicles and testing tracks, simulation-based plant model has great advantages in affordability, efficiency, and safety. In some embodiments, except the autonomous driving system 110, all other systems and servers are simulated by the simulator. In some embodiments, the plant model defines a list of driving scenarios to describe the evaluation setup including AD vehicle's initial position, equipped sensors, drivable area, and surrounding environmental dynamics (e.g., vehicles, pedestrians, traffic signals). The driving scenarios are formalized as human-readable configuration files for easy modification and contribution.

The bridge 403 of PASS serves as a communication channel between the AD and plant models, allowing sensor data to be read and the AD vehicle to be actuated. The bridge supports function hooking for modifying communication data at runtime for better extensibility.

In some embodiments, there are three types of plugins 405 of attacks or defenses in PASS. The plugins allow users to deploy their attacks and defenses directly in the platform. In particular, each plugin is designed as a Python API that takes different kinds of attacks or defenses as input. For example, physical-world attack plugin can load adversarial patches (e.g., stop-sign attacks) to the simulation world at arbitrary locations; AD-internal attack or defense plugin can replace simple AI components inside the AD systems; and sensor attack or defense plugin can modify/check sensor information on the bridge. For example, any one of the units in sensor system 114 as shown in FIG. 2 may be modified by an attack plugin.

Metric library 404 is in charge of collecting measurements from all other modules in the platform and calculating the scenario-dependent evaluation metrics. With the measurements from the plant model, metric library can quantify the impact of safety works at system-level (e.g., collision rate), traffic rule violation (e.g., lane departure rate), trip delay, etc. In some embodiments, component level metrics (e.g., frame-wise attack success rate) are provided for comprehensiveness.

In some embodiments, gaming engine-based 3D simulators, like SVL, CARLA, AirSim, Udacity, et al., are used to develop virtual safety testing methods.

In some embodiments, a virtual test case often appears as a configuration file that consists of static settings and dynamic settings. Static settings include the globally non-changing data under a simulation, like the high-definition map, the sensors, the autonomous vehicle model, the driving destination, etc. Dynamic settings contain the parameters whose values are changeable in simulation, such as the position of a surrounding non-player character (NPC) car, the traffic light signals, the weather and the light conditions, etc.

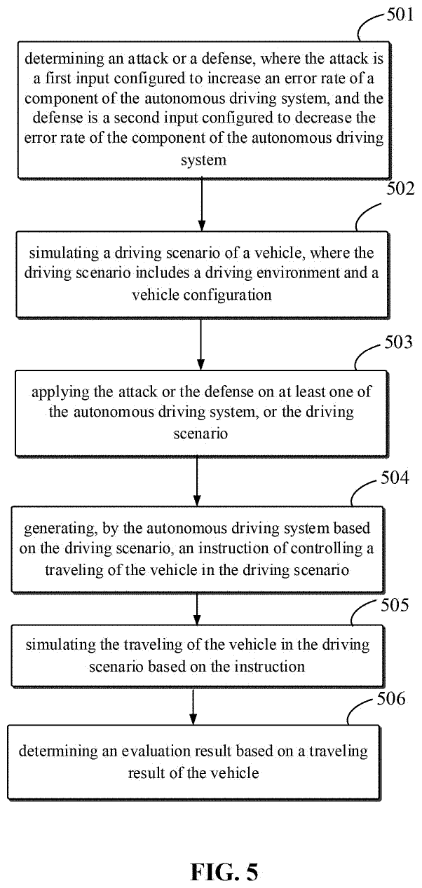

FIG. 5 illustrates a method for evaluating an autonomous driving system according to some embodiments of the disclosure. The method includes steps 501 to 506.

Step 501 includes: determining an attack or a defense, where the attack is a first input configured to increase an error rate of a component of the autonomous driving system, and the defense is a second input configured to decrease the error rate of the component of the autonomous driving system.

In some embodiments, the attack includes a backdoor program and the defense incudes an improved model.

In some embodiments, the vehicle configuration includes the control system and the sensor system as shown in FIG. 2.

In some embodiments, the attack includes a perturbation to the driving environment.

In some embodiments, the attack or the defense is a plugin. The plugin includes: a first plugin configured to load adversarial patches to the simulated driving scenario, a second plugin replacing the component of the autonomous driving system, or a third plugin configured to modify or check sensor data. In some embodiments, the first plugin loads an image of a stop sign into the driving environment. For example, an image of a stop sign is attached to a truck. In some embodiments, the second plugin replaces one of the modules 301 to 307 with a backdoor program. In some embodiments, the third plugin modifies a sensed signal of any one of units in the sensor system 114 of FIG. 2.

Step 502 includes: simulating a driving scenario of a vehicle, where the driving scenario includes a driving environment and a vehicle configuration.

In some embodiments, the driving environment includes: at least one of a pedestrian, a traffic light, a building, or a road, and the vehicle configuration includes: at least one of an initial position of the vehicle, the sensor system or a drivable area. In some embodiments, the vehicle configuration includes the sensor system 114, control system 111, wireless communication system 112. In some embodiments, the vehicle configuration further includes servers 103 and 104.

Step 503 includes: applying the attack or the defense on at least one of the autonomous driving system, or the driving scenario.

In some embodiments, the attack or the defense may be applied to the autonomous driving system, the simulated sensor system or the simulated driving environment.

In some embodiments, applying the attack or the defense on at least one of the autonomous driving system, or the driving scenario includes: replacing the component of the autonomous driving system with the backdoor program, or replacing the component of the autonomous driving system with the improved model. In some embodiments, the backdoor program has a same function as the replaced component and has a lower accuracy or a higher error rate than the replaced component. In some embodiments, the backdoor program has a same function as the replaced component, and has a different output from the replaced component with a given input. In some embodiments, the improved model has a same function as the replaced component and has a higher accuracy or a lower error rate than the replaced component. In some embodiments, the component is any one of modules 301 to 307.

In some embodiments, the attack includes modifying sensor data of a sensor in the sensor system, e.g., modifying a GPS signal of the GPS unit. In some embodiments, the defense includes signal authentication, and a signal authentication is performed on the sensor data. In some embodiments, the sensor data is any data sensed by a unit in the sensor system 114 as shown in FIG. 2. In some embodiments, GPS spoofing is performed on the GPS unit, and an error rate of the localization module 301 is increased. In some embodiments, the signal authentication is performed on the signal on the GPS unit, and the error rate of the localization module is decreased.

In some embodiments, applying the attack or the defense on at least one of the autonomous driving system, or the driving scenario includes: adding the perturbation to the driving environment of the driving scenario, where the perturbation includes at least one of image, text or voice. For example, the perturbation is a stop-sign image. In some embodiments, the perception module includes an object detection component and an object tracking component, the attack is a perturbation image, and the perturbation image is attached to an object (e.g., a truck) in the driving environment. With the perturbation image attached on the object, an accuracy of detecting the object by the object detection component is decreased, and the error rate of the object detection component is increased.

Step 504 includes: generating, by the autonomous driving system based on the driving scenario, an instruction of controlling a traveling of the vehicle in the driving scenario.

In some embodiments, the autonomous driving system (e.g., autonomous driving system 110 as shown in FIG. 3A) issues an instruction based on the simulated driving environment and the simulated vehicle configuration.

Step 505 includes: simulating the traveling of the vehicle in the driving scenario based on the instruction.

In some embodiments, a simulator SVL is used to simulate the traveling of the vehicle in the driving scenario based on the instruction.

Step 506 includes: determining an evaluation result based on a traveling result of the vehicle.

In some embodiments, the traveling result includes at least one of: a record of collision, a route of the traveling, or a duration of the traveling, and an evaluation result includes at least one of: a collision rate, a deviation from a lane, or a delay of a trip. In some embodiments, in response to determining that a collision rate is increased largely (e.g., more than 10 percent or more) by applying an attack to a component of the autonomous driving system, the evaluation result includes that the autonomous driving system is vulnerable to the attack. In some embodiments, in response to determining that a collision rate is decreased largely (e.g., more than 10 percent or more) by applying a defense to a component of the autonomous driving system, the evaluation result includes that the defense is effective to the autonomous driving system. In some embodiments, in response to determining that the collision rate is stable (e.g., the change of the collision rate does not larger than 5%), the evaluation result includes that the autonomous driving system is not vulnerable to the attack, or the defense is not effective to the autonomous driving system.

In some embodiments, in step 501, the attack or the defense is determined by selecting the attack, the defense or a combination of the attack and the defense from a first sub-interface, where the first sub-interface includes attacks, defenses or a combination of attacks and defenses.

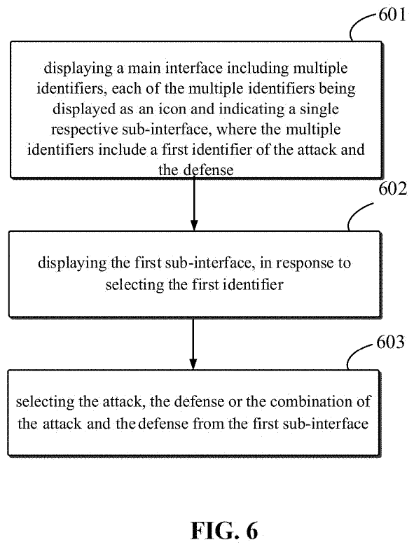

FIG. 6 illustrates an implementation of selecting the attack, the defense or a combination of the attack and the defense from a first sub-interface according to some embodiments of the disclosure.

Step 601 includes: displaying a main interface including multiple identifiers, each of the plurality of identifiers being displayed as an icon and indicating a single respective sub-interface, where the plurality of identifiers includes a first identifier of the attack and the defense.

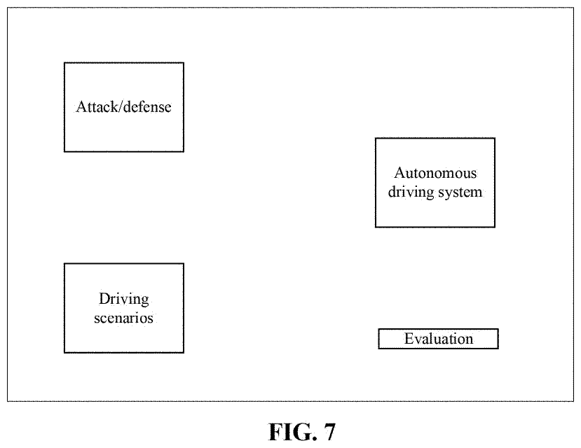

In some embodiments, an evaluation button is displayed in the main interface, and in response to pressing the evaluation button, an evaluation result is displayed. FIG. 7 illustrates a main interface of the PASS according to some embodiments of the disclosure.

Step 602 includes: displaying the first sub-interface, in response to selecting the first identifier.

In some embodiments, the first sub-interface includes multiple options of attacks, multiple options of defenses, or a combination thereof.

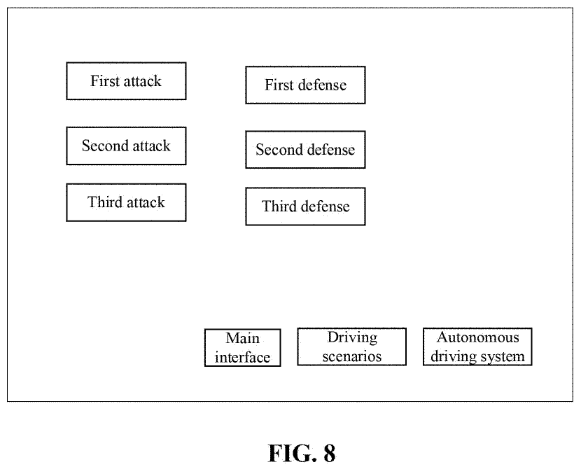

In some embodiments, while displaying the first sub-interface, displaying a row of other identifiers of other sub-interfaces and an identifier of the main interface, where the other identifiers includes a second identifier of the driving scenario and a third identifier of the autonomous driving system. FIG. 8 illustrates a first sub-interface according to some embodiments of the disclosure.

In some embodiments, in response to selecting an identifier from the other identifiers of other sub-interfaces and the identifier of the main interface, the sub-interface of the selected identifier or the main interface is displayed. In some embodiments, in response to selecting the second identifier, a second sub-interface is displayed. The second sub-interface includes setting of the driving scenarios. In some embodiments, the settings of the driving scenario include options of driving environment and options of vehicle configuration.

In some embodiments, in response to selecting the third identifier, a third sub-interface is displayed. The third sub-interface includes settings of the autonomous driving system. In some embodiments, settings of the autonomous driving system include options of replaceable modules.

Step 603 includes: selecting the attack, the defense or the combination of the attack and the defense from the sub-interface.

In some embodiments, by touching an icon indicating an attack or an icon indicating a defense in the first sub-interface, the attack or the defense is selected. By touching the evaluation button on the main interface, a simulation is started. After the simulation, an evaluation result is returned and displayed on the main interface.

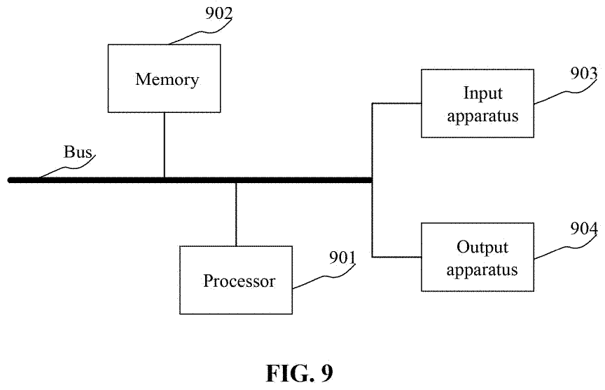

FIG. 9 illustrates an apparatus adapted to implement the method for evaluating an autonomous driving system according to some embodiments of the disclosure.

As shown in FIG. 9, the apparatus includes: one or more processors 901, a memory 902, and interfaces for connecting various components, including high-speed interfaces and low-speed interfaces. The various components are connected to each other using different buses, and may be mounted on a common motherboard or in other methods as needed. The processor may process instructions executed within the apparatus, including instructions stored in or on the memory to display graphic information of GUI on an external input/output apparatus (such as a display device coupled to the interface). In other embodiments, multiple processors and/or multiple buses may be used together with multiple memories if desired. Similarly, multiple apparatuses may be connected, and the apparatuses provide some necessary operations, for example, as a server array, a set of blade servers, or a multi-processor system. In FIG. 9, processor 901 is used as an example.

The memory 902 is a non-transitory computer readable storage medium provided by the present disclosure. The memory stores instructions executable by at least one processor, so that the at least one processor performs the method for evaluating an autonomous driving system according to some embodiments of disclosure. The non-transitory computer readable storage medium of the present disclosure stores computer instructions for causing a computer to perform the method for evaluating an autonomous driving system according to some embodiments of disclosure.

The memory 902, as a non-transitory computer readable storage medium, may be used to store non-transitory computer executable programs and modules, such as program instructions/modules corresponding to the method for evaluating an autonomous driving system according to some embodiments of disclosure. The processor 901 executes the non-transitory software programs, instructions, and modules stored in the memory 902 to execute various functional applications and data processing of the server, that is, to implement the method for evaluating an autonomous driving system according to some embodiments of disclosure.

The memory 902 may include a storage program area and a storage data area, where the storage program area may store an operating system and at least one function required application program; and the storage data area may store data created by the use of the apparatus of the method for evaluating an autonomous driving system according to some embodiments of disclosure. In addition, the memory 902 may include a high-speed random access memory, and may also include a non-transitory memory, such as at least one magnetic disk storage device, a flash memory device, or other non-transitory solid-state storage devices. In some embodiments, the memory 902 may optionally include memories remotely disposed with respect to the processor 901, and these remote memories may be connected to the apparatus of the method for evaluating an autonomous driving system according to some embodiments of disclosure. Examples of the above network include but are not limited to the Internet, intranet, local area network, mobile communication network, and combinations thereof.

The apparatus performing the method for evaluating an autonomous driving system according to some embodiments of disclosure may further include: an input apparatus 903 and an output apparatus 904. The processor 901, the memory 902, the input apparatus 903, and the output apparatus 904 may be connected through a bus or in other methods. In FIG. 9, connection through the bus is used as an example.

The input apparatus 903 may receive input digital or character information, and generate key signal inputs related to user settings and function control of the apparatus of the method for learning a knowledge representation, such as touch screen, keypad, mouse, trackpad, touchpad, pointing stick, one or more mouse buttons, trackball, joystick and other input apparatuses. The output apparatus 904 may include a display device, an auxiliary lighting apparatus (for example, LED), a tactile feedback apparatus (for example, a vibration motor), and the like. The display device may include, but is not limited to, a liquid crystal display (LCD), a light emitting diode (LED) display, and a plasma display. In some embodiments, the display device may be a touch screen.

It should be understood that the various forms of processes shown above may be used to reorder, add, or delete steps. For example, the steps described in the present disclosure may be performed in parallel, sequentially, or in different orders. As long as the desired results of the technical solution disclosed in the present disclosure can be achieved, no limitation is made herein.

The above specific embodiments do not constitute limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A method for evaluating an autonomous driving system, the method comprising:
determining an attack or a defense, wherein the attack is a first input configured to increase an error rate of a component of the autonomous driving system, and the defense is a second input configured to decrease the error rate of the component of the autonomous driving system;
simulating a driving scenario of a vehicle, wherein the driving scenario comprises a driving environment and a vehicle configuration;
applying the attack or the defense on at least one of the autonomous driving system, or the driving scenario;
generating, by the autonomous driving system based on the driving scenario, an instruction of controlling a traveling of the vehicle in the driving scenario;
simulating the traveling of the vehicle in the driving scenario based on the instruction; and
determining an evaluation result based on a traveling result of the vehicle,
wherein the method is performed by a processor.

2. The method according to claim 1, wherein the attack comprises a backdoor program and the defense comprises an improved model, wherein applying the attack or the defense on at least one of the autonomous driving system, or the driving scenario comprises: replacing the component of the autonomous driving system with the backdoor program, or replacing the component of the autonomous driving system with the improved model, wherein the backdoor program has a same function as the replaced component and has a lower accuracy or a higher error rate than the replaced component, and the improved model has the same function as the replaced component and has a higher accuracy or a lower error rate than the replaced component.

3. The method according to claim 1, wherein the vehicle configuration comprises a sensor, the attack comprises modifying sensor data of the sensor, and the defense comprises signal authentication, wherein applying the attack or the defense on at least one of the autonomous driving system, or the driving scenario comprises: modifying the sensor data of the sensor, or performing signal authentication on the sensor data.

4. The method according to claim 1, wherein the attack comprises a perturbation to the driving environment, wherein applying the attack or the defense on at least one of the autonomous driving system, or the driving scenario comprises: adding the perturbation to the driving environment of the driving scenario, wherein the perturbation comprises at least one of image, text or voice.

5. The method according to claim 1, wherein the attack or the defense is a plugin.

6. The method according to claim 5, wherein the plugin comprises: a first plugin configured to load adversarial patches to the simulated driving scenario, a second plugin replacing the component of the autonomous driving system, or a third plugin configured to modify or check sensor data.

7. The method according to claim 1, wherein the driving environment comprises: at least one of a pedestrian, a traffic light, a building, or a road, and the vehicle configuration comprises: at least one of an initial position of the vehicle, an sensor, or a drivable area.

8. The method according to claim 1, wherein the traveling result comprises at least one of: a record of collision, a route of the traveling, or a duration of the traveling, and an evaluation result comprises at least one of: a collision rate, a deviation from a lane, or a delay of a trip.

9. The method according to claim 1, wherein determining the attack or the defense comprises:
selecting the attack, the defense or a combination of the attack and the defense from a first sub-interface, wherein the first sub-interface comprises attacks, defenses or a combination of attacks and defenses.

10. The method according to claim 9, wherein selecting the attack, the defense or the combination of the attack and the defense from the first sub-interface comprises:
displaying a main interface comprising a plurality of identifiers, each of the plurality of identifiers being displayed as an icon and indicating a single respective sub-interface, wherein the plurality of identifiers has a first identifier of the attack and the defense;
displaying the first sub-interface, in response to selecting the first identifier; and
selecting the attack, the defense or the combination of the attack and the defense from the first sub-interface.

11. The method according to claim 10, wherein while displaying the first sub-interface, displaying a row of other identifiers of other sub-interfaces and an identifier of the main interface, wherein the other identifiers comprises a second identifier of the driving scenario and a third identifier of the autonomous driving system; and
in response to selecting an identifier from the other identifiers of other sub-interfaces and the identifier of the main interface, displaying the sub-interface of the selected identifier or the main interface.

12. The method according to claim 9, wherein determining the evaluation result based on the traveling result of the vehicle comprises: displaying a main interface comprising an evaluation button; and displaying an evaluation result, in response to pressing the evaluation button.

13. An apparatus, comprising:
a processor; and
a memory storing instructions, which when executed by the processor, cause the processor to perform operations, the operations comprising:
determining an attack or a defense, wherein the attack is a first input configured to increase an error rate of a component of an autonomous driving system, and the defense is a second input configured to decrease the error rate of the component of the autonomous driving system;
simulating a driving scenario of a vehicle, wherein the driving scenario comprises a driving environment and a vehicle configuration;
applying the attack or the defense on at least one of the autonomous driving system, or the driving scenario;
generating, by the autonomous driving system based on the driving scenario, an instruction of controlling a traveling of the vehicle in the driving scenario;
simulating the traveling of the vehicle in the driving scenario based on the instruction; and
determining an evaluation result based on a traveling result of the vehicle.

14. The apparatus according to claim 13, wherein the attack comprises a backdoor program and the defense comprises an improved model, wherein applying the attack or the defense on at least one of the autonomous driving system, or the driving scenario comprises: replacing the component of the autonomous driving system with the backdoor program, or replacing the component of the autonomous driving system with the improved model, wherein the backdoor program has a same function as the replaced component and has a lower accuracy or a higher error rate than the replaced component, and the improved model has the same function as the replaced component and has a higher accuracy or a lower error rate than the replaced component.

15. The apparatus according to claim 13, wherein the vehicle configuration comprises a sensor, the attack comprises modifying sensor data of the sensor, and the defense comprises signal authentication, wherein applying the attack or the defense on at least one of the autonomous driving system, or the driving scenario comprises: modifying the sensor data of the sensor, or performing signal authentication on the sensor data.

16. The apparatus according to claim 13, wherein the attack comprises a perturbation to the driving environment, wherein applying the attack or the defense on at least one of the autonomous driving system, or the driving scenario comprises: adding the perturbation to the driving environment of the driving scenario, wherein the perturbation comprises at least one of image, text or voice.

17. The apparatus according to claim 13, wherein the attack or the defense is a plugin, and the plugin comprises: a first plugin configured to load adversarial patches to the simulated driving scenario, a second plugin replacing the component of the autonomous driving system, or a third plugin configured to modify or check sensor data.

18. The apparatus according to claim 13, wherein the driving environment comprises: at least one of a pedestrian, a traffic light, a building, or a road, and the vehicle configuration comprises: at least one of an initial position of the vehicle, an sensor, or a drivable area.

19. The apparatus according to claim 13, wherein the traveling result comprises at least one of: a record of collision, a route of the traveling, or a duration of the traveling, and an evaluation result comprises at least one of: a collision rate, a deviation from a lane, or a delay of a trip.

20. A non-transitory storage medium storing instructions which when executed by a processor, cause the processor to perform operations, the operations comprising:
determining an attack or a defense, wherein the attack is a first input configured to increase an error rate of a component of an autonomous driving system, and the defense is a second input configured to decrease the error rate of the component of the autonomous driving system;
simulating a driving scenario of a vehicle, wherein the driving scenario comprises a driving environment and a vehicle configuration;
applying the attack or the defense on at least one of the autonomous driving system, or the driving scenario;
generating, by the autonomous driving system based on the driving scenario, an instruction of controlling a traveling of the vehicle in the driving scenario;
simulating the traveling of the vehicle in the driving scenario based on the instruction; and
determining an evaluation result based on a traveling result of the vehicle.
